(19) United States
(12) Patent Application Publication
(10) Pub. No.: US 2006/0025099 A1
(43) Pub. Date: Feb. 2, 2006

(54) Apparatus and method for downward mixing an input signal into an output signal

(76) Inventors: Peter Jung, Otterberg (DE); Soeren Sappok, Stolberg (DE)

Correspondence Address: GLENN PATENT GROUP, 3475 EDISON WAY, SUITE L, MENLO PARK, CA, 94025, US

(21) Appl. No.: 11/188,162

(22) Filed: Jul. 21, 2005

Related U.S. Application Data
(63) Continuation of application No. PCT/EP03/13713, filed on Dec. 4, 2003.

(30) Foreign Application Priority Data
Jan. 23, 2003 (DE) 10302647.9

(51) Int. Cl. H04B 1/26; H04B 15/00

(52) U.S. Cl. 455/313

(57) ABSTRACT

Device for downward mixing an input signal into an output signal includes means for generating a first receive signal and a second receive signal on a first intermediate frequency, a converter means for analog/digital converting the first and the second receive signals on the first intermediate frequency, a phase detection means for detecting a phase difference between a digital representation of the first receive signal and the second receive signal, a first mixer means and a second mixer means for converting the respective digital representations onto a second intermediate frequency, a mixer control means and a summation means, wherein the phase detection means is implemented in order to control means for generating and/or mixer control means so that the output signals of the first and the second mixer means are in a predetermined phase relation to each other, so that an image frequency rejection occurs after a summation. By this it is achieved that the device for downward mixing is basically integrable and that an efficient image frequency rejection is obtained.

### CROSS-REFERENCE TO RELATED APPLICATIONS

This application is a continuation of co-pending International Application No. PCT/EP03/13713, filed Dec. 4, 2003, which designated the United States and was not published in English.

### BACKGROUND OF THE INVENTION

1. Field of the Invention

The present invention relates to analog or digital transmission technologies and in particular to receive structures for downward mixing input signals.

2. Description of the Related Art

The quick distribution of modern transmission technologies that are, for example, used in a mobile radio transmission, present a great challenge for the design of high-frequency receivers (RF receivers). On the one hand, the importance of cheap and efficient receive structures is growing, which can, preferably with the help of digital technology, be employed in mobile receive parts, which are getting smaller and smaller. For this reason it is important that the receive structures or that parts of the receive structures, respectively, may be realized, for example, with the help of MOS technology (MOS=metal oxide semiconductor). On the other hand, it is important with regard to growing transmission rates to use receive structures that convert such transmission signals sufficiently accurately, for example from one frequency range to which a carrier frequency is associated into another frequency range to which a selectable intermediate frequency is associated, so that data is accurately demodulated and detected, which is desirable in particular with regard to obtaining low bit error probabilities.

With the growing spread of the most different mobile radio standards, like for example the GSM standard or the UMTS standard, it is necessary that the receive structures are flexible enough so that they may, for example, be employed in a receive device for downward mixing receive signals which are associated with different mobile radio standards. To this end, receiver concepts are required facilitating as many standards as possible by a use of suitable RF receivers. For a design of such receivers, apart from costs, size, and power consumption, also integration levels and obtaining a marketable position of the respective prototypes (time-to-market) as fast as possible are of decisive importance.

The simplest approach for downward mixing a high-frequency signal is the homodyne receiver (direct down receiver or zero intermediate frequency receiver). In FIG. 1, a basic setup of a homodyne receiver is illustrated as it is known from the prior art.

The receiver illustrated in FIG. 1 includes a receive antenna 101, a band-pass filter (RF band pass) 103, a low-noise amplifier 105 (LNA), a branch point 107, a first mixer 109, a second mixer 111, wherein both mixers are controllable, a first low-pass filter 113, a second low-pass filter 115 and a demodulator 117.

The input signal received via the antenna 101 is first of all filtered by the band-pass filter 103 and supplied to the LNA 105. The band-pass filtered and amplified receive signal is split up at the branch point 107 into a first and into a second partial receive signal. The first partial receive signal is supplied to the mixer 109, the second partial receive signal is supplied to the mixer 111. The mixer 109 is controlled using a first control signal cos (ω_{T}t), the second mixer 11 is controlled using a second control signal sin (ω_{T}t). ω_{T} designates a carrier frequency here which is associated with the received high-frequency input signal. The two mixers 109 and 111 thus cause a baseband mixing of the receive signal. The quadrature components I and Q which resulted after the baseband mixing are respectively supplied to the low-pass filters 113 and 115 in order to select a desired channel for a subsequent demodulation by the demodulator 117. The quadrature components are then supplied to the demodulator 117 where they are demodulated depending on the employed modulation form (for example a quadrature amplitude modulation), so that subsequently a detection of the transmitted data may take place.

The disadvantage about the homodyne receiver illustrated in FIG. 1 is that the two control signals that are required for the mixers 109 and 111 have to be generated by a local oscillator, wherein the local oscillator comprises an oscillation frequency which is equal to the carrier frequency. It turns out to be difficult to generate a high-frequency tunable oscillator frequency. The same not only has to be highly precise but also has to generate two output signals phase shifted by 90 degrees in order to downward mix I/Q-modulated signals. A slight deviation (I/Q mismatching, for example in the case of a QAM modulation (QAM=quadrature amplitude modulation), leads to distortions of a signal space constellation, in which both amplitude and phase inaccuracies occur. This leads to an increased bit error probability (BER). This mismatching may, for example, be caused by amplitude or phase inaccuracies resulting at the respective mixer 109 or 111.

A further disadvantage of the homodyne receiver illustrated in FIG. 2 is that after the baseband mixing DC voltage proportions result that occur as interference signals in the base band and interfere with the desired signals. These DC voltage proportions may, however, be eliminated with the help of a capacitor (AC coupling), but here a narrow-band filtering is required, requiring a long settling time, which may, for example, with a TDD signal (TDD=time domain duplex) lead to the fact that the signal may not be received in time.

A further disadvantage of the homodyne receiver illustrated in FIG. 1 is a noise which is in particular multistage-amplified at a respective output of the respective mixer 109, 111. By a direct noise transformation into the base band, in this low-frequency range the 1/f noise dominates a complete noise level. If a homodyne receiver, as it is illustrated in FIG. 1, is manufactured with the help of MOS technology, then in particular when using the MOS transistors the 1/f noise has strong effects which possibly excludes a use of, for example, a CMOS technology for manufacturing the homodyne mixer.

The mismatching may, for example, result from inaccuracies in controlling the respective mixer 109 or 111. If, for example, a phase difference between the two control signals that are used for a multiplication with the respective partial receive signal in the respective mixer 109 and 111 is present, then the quadrature components applied to the inputs of the demodulator 117 are not exactly phase-shifted to each other by 90 degrees, which leads to an increase of the bit error probability. With a deviation of the oscillator frequency from the frequency of the carrier, the signal is further not exactly shifted into the base band, so that a subsequent demodulation is complicated, which leads to an increase of the bit error probability.

In addition to this, the use of a homodyne receiver, as it is illustrated in FIG. 1, is problematic if receive signals have to be downward-mixed, who respectively have a different associated carrier frequency, as it is for example the case in a GSM or also a UMTS receive signal, as the local oscillator would respectively have to be tunable in a wide frequency range which is difficult to realize in practice at low cost, however.

Due to the described problems, for a downward mixing of high-frequency signals heterodyne receivers may be used. FIG. 2 shows a heterodyne receiver as it is known from the prior art. This is a receive structure known as “Hartley structure”.

In contrast to the homodyne receiver illustrated in FIG. 1, in the heterodyne receiver illustrated in FIG. 2, the two partial receive signals resulting after the branch point 107 are supplied to the mixers 109 and 111, which are respectively controlled by control signals whose oscillator circuit frequency (ω_{LO}) is different from the carrier frequency of the high-frequency receive signal. In addition to this, the heterodyne receiver illustrated in FIG. 2 includes a phase shifter 201 to which a signal is supplied which is applied to the output of the mixer 111. The output signals of the mixer 109 and the phase shifter 201 are supplied to a summator 203 and an output signal of the summator 203 is branched at a further branch point 205, so that a first 2051 and a second 2053 partial signal result. The first partial signal 2051 is supplied to a third mixer 207 and the second partial receive signal 2053 is supplied to a fourth mixer 209. The third mixer 207 is controlled here using a control signal cos (ω_{IF}t), the fourth mixer 209 is controlled using a control signal −sin (ω_{IF}t). The partial receive signals that resulted at the respective outputs of the mixers 207 and 209 are respectively supplied to the low-pass filters 113 and 115 and subsequently demodulated in the demodulator 117.

The two partial components of the receive signal are first of all converted with the help of the first mixer 109 and the second mixer 111 to a suitable intermediate frequency which depends on the frequency ω_{LO} of the two control signals. Both control signals are generated with the help of a local oscillator whose angular oscillator frequency is ω_{LO}. As now the frequency of the local oscillator signal does not correspond to the carrier frequency, at the outputs of the mixers 109 and 111 mixed products result rejected by a suitable filtering not indicated in FIG. 2. In addition to this, at the outputs of the mixers 109 and 111 signal proportions result spaced apart from each other by double the intermediate frequency around an oscillator frequency f_{LO}. In order to select a channel it is necessary, however, to select only one signal proportion, which is not possible, however, by a mere filtering of the IF signals.

In order to filter out a channel, the receive signal may be filtered to the first intermediate frequency using an image frequency rejection filter before mixing, as is known from the prior art. A disadvantage of this approach is, however, that such filters are difficult to manufacture in MOS technology, as a manufacturing of coils with a sufficient quality is difficult. For this reason, such elements have to be set up discretely and may therefore not be integrated on a chip. Here, for example SAW filters (SAW=surface acoustic wave), ceramic or dielectric filters may be used as a filter. Instead of using image frequency rejection filters, the image frequencies may be rejected using trigonometric theorems, as it is the case in the heterodyne receiver illustrated in FIG. 2. Here, the output signal of the mixer 111 is additionally phase-shifted with the help of the phase shifter 201 by 90 degrees, so that after the addition performed in the summator 203, the image frequencies may be rejected. Afterwards, the first partial signal 2051 and the second partial signal 2053 are converted to a second intermediate frequency with the help of the mixers 207 and 209, which depends on the angular frequency ω_{IF} of the control signals. After the low-pass filtering by the low passes 113 and 115, the quadrature components are demodulated and the demodulated data is detected.

For achieving the required 180-degree phase difference between the signals applied to the summator 203, the phase shifter 201 shown in FIG. 2 may be omitted when the output signals of the mixers 109 and 111 are additionally converted to another intermediate frequency with the help of a further mixer pair.

FIG. 3 shows a basic setup of a heterodyne receiver, as it is known from the prior art. This is an image frequency rejection receiver known under the name of “Weaver structure” from the document by D. Verver: A third method of generation and detection of single sideband signals”, Proc. IRE, Vol. 44, 1956.

The receive structure illustrated in FIG. 3, in contrast to the heterodyne receiver illustrated in FIG. 2, comprises a fifth mixer 301 and a sixth mixer 303. The mixers 109 and 111 are respectively controlled using a control signal cos (ω_{LO1}t) and −sin (ω_{LO1}t), so that the respective partial receive signals are converted to a first intermediate frequency. The converted partial receive signals are further converted by the mixers 301 and 303 to a second intermediate frequency. For this purpose, the mixers 301 and 303 are respectively controlled using a control signal cos (ω_{LO2}t) and −sin (ω_{LO2}t). By this, the output signals of the mixers 109 and 111 are converted to the second intermediate frequency after a possible filtering not indicated in FIG. 3. Due to the summation of the output signals of the mixers 301 and 303 performed at the summator 203, now signal proportions are in the ideal case rejected at an image frequency, so that at an output of the summator 203 a single sideband signal results.

One disadvantage of the heterodyne receiver illustrated in FIG. 2 or in FIG. 3 is, that with a mismatching between the I component at the output of the mixer 301 and the Q component at the output of the mixer 303 a low image signal attenuation is achieved. Already a slight phase or also an amplitude deviation between the signals at the outputs of the mixers 301 and 303, which may, for example, result from manufacturing-specific part tolerances, leads to a decreased image frequency rejection. A phase or amplitude deviation may, for example, result when the two control signals controlling the mixers 109 and 111 are not exactly phase-shifted to each other by 90 degrees. The same problems occur when the two control signals controlling the mixers 301 and 303 have no exact phase shifting by 90 degrees. Due to an analog design of the heterodyne receivers illustrated in FIG. 2 and FIG. 3, the mismatching between the I and the Q components may not be ruled out.

A further disadvantage of the heterodyne receiver illustrated in FIG. 2 or in FIG. 3 is that they are not flexible enough in order to, for example, convert high-frequency input signals to the first intermediate frequency when different carrier frequencies are associated with the input signals, as it is for example the case with a multi-standard reception. The reason for this non-flexibility is that the respective control signals are generated by analogy with the help of local oscillators. In order to, for example, convert different high-frequency receive signals that have a respectively different associated carrier to the first intermediate frequency at the output of the mixers 109 and 111, it is required that a local oscillator generating the two control signals for the mixers 109 and 111 is tunable sufficiently accurately in a wide frequency range. If the two signals resulting at the outputs of the mixers 109 and 111 are mismatched due to the non-exact 90-degree shift between the two control signals, then this mismatching is propagated, because due to an analog conversion by the mixers 301 and 303 the phase of the resulting I and Q components may not be corrected.

It is a further disadvantage of the heterodyne receivers according to the prior art illustrated in FIG. 2 and in FIG. 3, that they are expensive and difficult to be integrated due to the employed analog components. In addition to this, with the employed analog mixers 109, 111, 301, 303, 207 and 209 no exact multiplication is possible, so that an exact intermediate frequency conversion of the respective signals may not be achieved, which leads to an increase of the bit error probability. In addition to this, at the non-linearities of the analog components further inter-modulation frequencies are generated which interfere and lead to a further increase of the bit error probability. In addition to this, a slight deviation of the partial receive signals applied to the inputs of the summator 203 with regard to the phase or the amplitude, have a substantial effect on the image frequency rejection, which leads to a further increase of the bit error probability. For this reason it is compulsory to implement the paths via which the two partial receive signals are transmitted as symmetric as possible with regard to an attenuation and to use oscillators that are as stable as possible for generating the respective control signals for the mixers, which leads to a significant cost increase of such heterodyne structures. Due to an analog implementation of all used mixers it is necessary to optimize the mixers with regard to their noise performance. This is very expensive, however, as the demands on the mixer are increased due to a broad-band operation range, if the receive structures are used for downward mixing receive signals respectively comprising different carrier frequencies.

### SUMMARY OF THE INVENTION

It is the object of the present invention to provide an efficient concept for downward mixing receive signals.

In accordance with a first aspect, the present invention provides a device for downward mixing an input signal into an output signal, having a generator for generating a first receive signal and a second receive signal on a first intermediate frequency, wherein the generator for generating is implemented in order to generate the first receive signal and the second receive signal with a predetermined first phase relation to each other; a converter for analog/digital converting the first receive signal on the first intermediate frequency in order to obtain a digital representation of the first receive signal and for analog/digital converting the second receive signal in order to obtain a digital representation of the second receive signal; a phase detector for detecting a phase difference between the digital representation of the first receive signal and the digital representation of the second receive signal; a first mixer for converting the digital representation of the first receive signal onto a second intermediate frequency; a second mixer for converting the digital representation of the second receive signal onto the second intermediate frequency; a mixer controller for controlling the first mixer with a first control signal comprising a first frequency and for controlling the second mixer with a second control signal comprising the first frequency, wherein the first and the second control signal comprise a predetermined first phase difference; a summator for summing the output signals of the first mixer and the second mixer; wherein the phase detector is implemented in order to control the generator for generating in order to reduce a mismatch between the digital representation of the first receive signal and the digital representation of the second receive signal and to control the mixer controller in order to digitally compensate a remaining mismatch between the digital representation of the first receive signal and the digital representation of the second receive signal so that the output signals of the first mixer and the second mixer are in a predetermined phase relation to each other, so that an image frequency rejection occurs.

In accordance with a second aspect, the present invention provides a method for downward mixing an input signal into an output signal, with the steps of generating a first receive signal and a second receive signal on a first intermediate frequency; generating a predetermined first phase relation between the first receive signal and the second receive signal; analog/digital converting the first receive signal on the first intermediate frequency in order to obtain a digital representation of the first receive signal, and analog/digital converting the second receive signal on the first intermediate frequency in order to obtain a digital representation of the second receive signal; detecting a phase difference between the digital representation of the first receive signal and the digital representation of the second receive signal; changing a phase relation between the first receive signal and the second receive signal in order to reduce a mismatch between the digital representation of the first receive signal and the digital representation of the second receive signal; generating a first control signal and a second control signal for converting the digital representation of the first receive signal and the digital representation of the second receive signal to a second intermediate frequency; generating a predetermined phase difference between the first and the second control signal in order to digitally compensate for a remaining mismatch between the digital representation of the first receive signal and the digital representation of the second receive signal in the conversion to the second intermediate frequency; converting the digital representation of the first receive signal and the digital representation of the second receive signal to the second intermediate frequency, so that the converted digital representation of the first receive signal and the converted digital representation of the second receive signal are in a predetermined phase relation to each other; summing the converted digital representation of the first and the second receive signal so that an image frequency rejection occurs based on the predetermined phase relation.

In accordance with a third aspect, the present invention provides a computer program having a program code for performing the above-mentioned method when the computer program runs on a computer.

The inventive device for downward mixing an input signal into an output signal comprises means for generating a first input signal and a second input signal on a first intermediate frequency, wherein means for generating is implemented to generate the first receive signal and the second receive signal with a predetermined first phase relation to each other, a converter means for analog/digital converting the first receive signal on the first intermediate frequency in order to obtain a digital representation of the first receive signal and for analog/digital converting the second receive signal in order to obtain a digital representation of the second receive signal, a phase detection means for detecting a phase difference between the digital representation of the first receive signal and the digital representation of the second receive signal, a first mixer means for converting the digital representation of the first receive signal to a second intermediate frequency, a second mixer means for converting the digital representation of the second receive signal to the second intermediate frequency, a mixer control means for controlling the first mixer means with a first control signal comprising a first frequency and for controlling the second mixer means with a second control signal comprising the second frequency, wherein the first and the second control signals comprise a predetermined phase difference, a summation means for summing the output signals of the first and the second mixer means, wherein the phase detection means is implemented to control means for generating and/or mixer control means so that the output signals of the first and the second mixer means are in a predetermined phase relation to each other, so that an image frequency rejection occurs.

The present invention is based on the finding that an accurate image frequency rejection may be achieved in downward mixing when parts of the device for downward mixing are implemented digitally.

It is an advantage of the present invention that the image frequency rejection may be performed accurately, as possible phase, frequency or amplitude differences between the first and the second receive signal may be digitally detected by the phase detection means, so that mismatchings between the possible signals on the first intermediate frequency and/or between the possible signals on the second intermediate frequency may be corrected.

It is a further advantage of the present invention that the inventive device for downward mixing is basically integrable, as the performance-determining components of the inventive device are implemented for a digital signal processing. In addition to that, this leads to a decrease of the manufacturing costs, the power consumption and the area consumption.

It is a further advantage of the present invention that a conversion of the respective digital representation of the first and/or the second receive signal is performed digitally. Thus, the downward mixing is reduced to a digital multiplication which may be realized cost-effectively with the help of efficient digital algorithms. For controlling the digital mixer means, the respective control signals are generated digitally, so that a desired frequency and phase shift between the control signals may be realized accurately, wherein for this purpose neither local oscillators nor phase shifters have to be employed. On the one hand, by this the manufacturing costs are decreased, on the other hand, an accurate conversion of the respective mixer input signals to the second intermediate frequency is achieved, so that apart from an efficient image frequency rejection also the bit error probability in the subsequent demodulation and detection is reduced.

It is a further advantage of the present invention that the frequency, the phase and/or the amplitude of the digital representation of the first and/or the second receive signal may be calculated with a suitably selected algorithm, for example the already mentioned CORDIC algorithm. By this, possible phase, frequency or amplitude errors may be calculated accurately and quickly and be compensated in a further step.

It is a further advantage of the present invention that the inventive device for downward mixing may be used in a multi-standard receiver. A multi-standard receiver is especially distinguished by the fact that it is implemented for receiving receive signals to which a respectively different carrier frequency may be associated.

### BRIEF DESCRIPTION OF THE DRAWINGS

Preferred embodiments of the present invention are explained in more detail in the following with reference to the accompanying drawings, in which:

FIG. 1 shows a basic setup of a homodyne receiver;

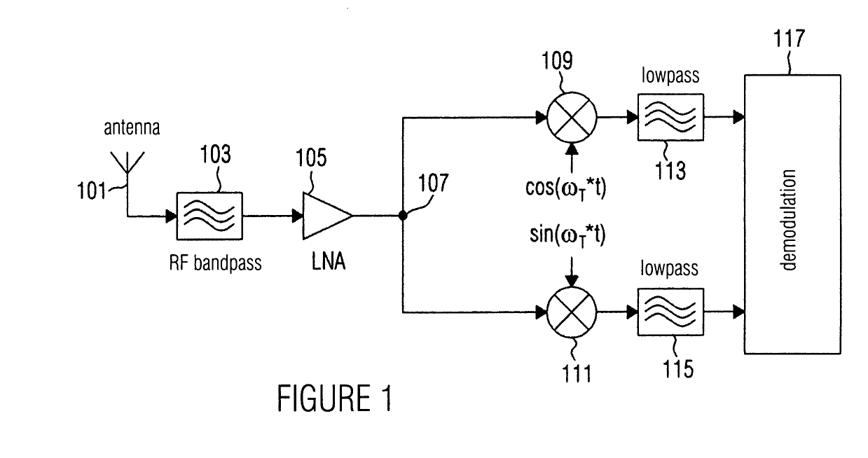

FIG. 2 shows a basic setup of a heterodyne receiver based on the example of a Hartley structure;

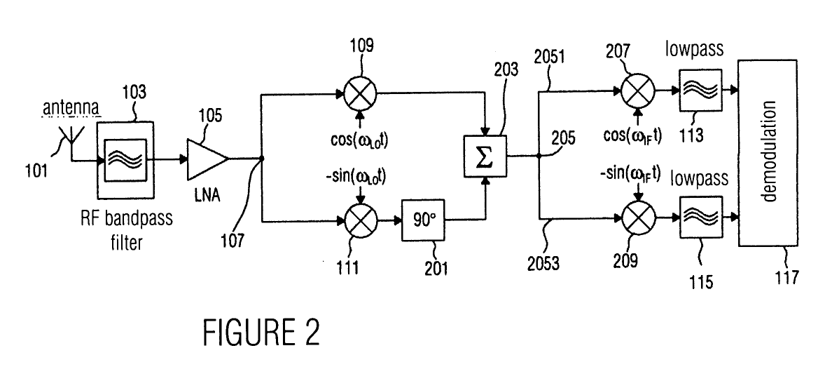

FIG. 3 shows a schematic setup of a heterodyne receiver based on the example of a Weaver structure;

FIG. 4 shows a first embodiment of a device for downward mixing according to the present invention;

FIG. 5 shows a further embodiment of a device for downward mixing according to the present invention;

FIG. 6 shows a further embodiment of a device for downward mixing according to the present invention;

FIG. 7 shows a further embodiment of a device for downward mixing according to the present invention;

FIG. 8 shows an embodiment of a frequency selection means according to the present invention; and

FIG. 9 shows a simulation result of an image reject ratio when using analog receive structures.

### DESCRIPTION OF THE PREFERRED EMBODIMENTS

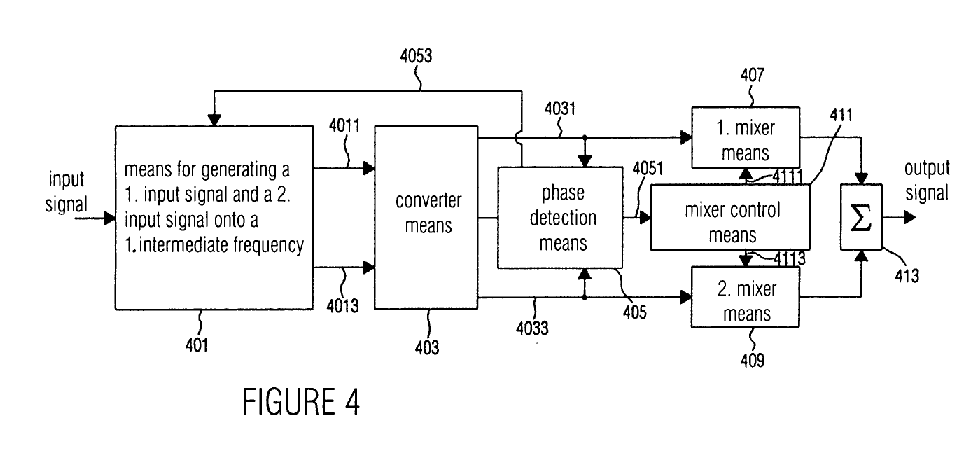

In FIG. 4, an embodiment of the inventive device for downward mixing an input signal is illustrated. An input signal is supplied to means 401 for generating a first receive signal 4011 and a second receive signal 4013 on a first intermediate frequency. The first receive signal 4011 and the second receive signal 4013 are received from a converter means 403. The converter means 403 provides a digital representation 4031 of the first receive signal 4011 and a digital representation 4033 of the second receive signal 4013.

The digital representation 4031 of the first receive signal 4011 is supplied to a phase detection means 405 and a first mixer means 407. The digital representation 4033 of the second receive signal 4013 is supplied to the phase detection means 405 and a second mixer means 409. The embodiment of the inventive device illustrated in FIG. 4 for downward mixing further includes a mixer control means 411 controlling the first mixer means 407 using a first control signal 4111 and controlling the second mixer means 409 using a second control signal 4113. An output signal of the first mixer means 407 and an output signal of the second mixer means 409 are supplied to a summation means 413 for summing the output signals of the first and the second mixer means, wherein the summation means 413 provides an output signal. The phase detection means 405 further provides a first signal 4051 for controlling the mixer control means 411 and a second signal 4053 for controlling means 401 for generating.

In the following, the functioning of the embodiment of the inventive device for downward mixing illustrated in FIG. 4 is explained.

Means 401 for generating receives the input signal which may be a high-frequency signal and generates, on the basis of the input signal, the first receive signal 4011 and the second receive signal 4011 on the first intermediate frequency. Here, the first receive signal 4011 and the second receive signal have a predetermined first phase relation to each other. For generating the first and the second receive signal, means 401 for generating may, for example, comprise a balanced ring modulator for generating the first and the second receive signal on the first intermediate frequency based on an input signal that may have an associated carrier frequency. It is conceivable, however, that means 401 for generating comprises other means, like, for example, suitably controlled analog mixers by which the two receive signals 4011 and 4013 may be generated on the first intermediate frequency. If the first receive signal 4011 and the second receive signal 4013 differ by 90 degrees with regard to a phase at the same frequency, then they are quadrature signals, wherein the first receive signal 4011 for example represents an I component and the second receive signal 4013 represents a Q component. Preferably, however, a desired phase relation may be created between the first receive signal 4011 and the second receive signal 4013 by means 401 for generating, so that the predetermined first phase relation may be generated. The two receive signals 4011 and 4013 are then supplied to the converter means 403 on the first intermediate frequency for analog/digital converting. The converter means 403 may, for example, respectively comprise an analog/digital converter for every path. Alternatively, it is conceivable, however, that the analog/digital conversion is performed with the help of an analog/digital converter which is suitably clocked and controlled for this purpose. When using two analog/digital converters, maintaining the sampling theorem, one digital representation 4031 and one digital representation 4033 of the first receive signal 4011 and the second receive signal 4013 is generated, respectively. If, for example, only one analog/digital converter is used, then it is for example possible to control the analog/digital converter alternately with the first receive signal 4011 and with the second receive signal 4013, which may, for example, be realized with the help of an analog multiplexer. If the analog/digital converter comprises a sufficiently high sampling rate, for example a sampling rate several times as high as it is required for maintaining the sampling theorem, then at the output of the analog/digital converter the digital representation 4031 of the first receive signal 4011 and the digital representation 4033 of the second receive signal 4013 may be always obtained.

As, after the conversion of the receive signal to the first intermediate frequency and after the analog/digital conversion, digital signals are present, the phase detection means 405, the first mixer means 407, the mixer control means 411, the second mixer means 409 and the summation means 413 may be implemented digitally. In this case, the digital representation 4031 of the first receive signal 4011 and the digital representation 4033 of the second receive signal are converted by a digital mixing to a second intermediate frequency. The digital mixing is realized by the first mixer means 407 and by the second mixer means 409. For converting the signals 4031 and 4033 to the second intermediate frequency, the first mixer means 407 and the second mixer means 409 are controlled by the mixer control means 411 using the digital control signals 4111 and 4113. As the first control signal 4111 and the second control signal 4113 are digital, a first frequency comprising the first control signal 4111 and the second control signal 4113 may be accurately set by the mixer control means 411. In addition to this, the control signals 4111 and 4113 may be generated by the mixer control means 411 such that they comprise a predetermined first phase difference which may be set accurately. By the digital conversion of the signals 4031 and 4033 and by the digital control of the first mixer means 407 and 409 the two mixer output signals may always be created with the characteristic that after summing the two output signals by the summation means 413 an accurate image frequency rejection takes place. A precondition for this is, however, that a mismatching between the receive signals 4011 and 4013 and a mismatching between the digital representation 4031 of the first receive signal 4011 and the digital representation 4033 of the second receive signal 4013 are reduced. This means in particular that the two output signals of the first mixer means 407 and the second mixer means 409 comprise a predetermined second phase relation to each other, so that by the summation an optimum image frequency rejection takes place. If, for example, the image frequency signal proportions that have to be rejected are not exactly shifted by 180 degrees to each other, then they are not completely eliminated after the summation by the summation means 413, so that the output signal may comprise interfering image frequency signal proportions.

In order to set the second phase relation of the output signals of the first and the second mixer means 407 and 409 which are required for eliminating image frequency proportions, it is required first of all that both the first frequency and also the first phase difference of the first and the second control signals 4111 and 4113, generated by the mixer control means, are set accurately.

In order to set the desired first phase relation of the two mixer output signals, by the phase detection means 405 first of all a phase of the digital signals 4031 and 4033 is detected on the first intermediate frequency. According to the invention, however, the phase detection means 405 may be implemented such that a phase shift between the two digital signals 4031 and 4033 is algorithmically detected on the first intermediate frequency. In order to either detect the respective phase of the signals 4031 and/or 4033 or the phase shift between the two signals 4031 and 4033, for example the above-mentioned CORDIC algorithm may be used. The CORDIC algorithm allows calculating a plurality of mathematical operations, like, for example, divisions, multiplications or a calculation of any trigonometric functions, by performing the mathematical operation to be calculated with the help of vector rotations.

Depending on the phase of the digital signals 4031 and 4033 or on their phase shift, respectively, the phase detection means 4033 controls means 401 for generating such that the first receive signal 4011 and the second receive signal 4013, which are analog in this embodiment, comprise the first phase relation to each other, so that considering possible run-time differences the second phase relation of the mixer output signal required for an image frequency rejection is achieved. The phase detection means 405 further controls the mixer control means 411 in order to accurately set both the first frequency of the first and the second control signals 4111 and 4113 so that the digital signals 4031 and 4033 are exactly converted to the second intermediate frequency. The phase detection means 405 controls the mixer control means 411 further such that the control signals 4111 and 4113 comprise the first phase difference, so that after the summation of the two mixer output signals the image frequency rejection may be achieved. If, for example, the phase shift of the digital signals 4031 and 4033 on the first intermediate frequency is too low in order to achieve an optimum image frequency rejection, then means 401 is controlled by the phase detection means 405 such that a phase shift between the first receive signal 4011 and the second receive signal 4013 is increased. If, however, the phase shift between the digital signals 4031 and 4033 is too large, then means 401 is controlled such that the phase shift between the first receive signal 4011 and the second receive signal 4013 is decreased.

The phase detection means 405 may further, based on the phase shift between the digital signals 4031 and 4033, control means 401 such that the first and the second receive signals 4011 and 4013 are exactly converted to the first frequency, so that no frequency shift occurs. As the receive signals 4011 and 4013 are converted with the help of analog components, a sufficiently accurate setting of the first phase relation of the first and the second receive signals 4011 and 4013 to each other is not possible. In addition to this, an exact maintaining of the first intermediate frequency is not possible. These mismatchings may be corrected digitally, however, by the phase detection means 405 controlling the mixer control means 411 such that the control signals 4111 and 4113 comprise the desired first phase difference and the first frequency, so that possible mismatchings on the analog side are compensated at the outputs of the mixer means 407 and 409.

In the embodiment of the inventive device for downward mixing illustrated in FIG. 4 it was assumed for reasons of clarity that both the first mixer means and also the second mixer means cause no additional phase shift of the output signals on the second intermediate frequency. If this is not the case, then the phase detection means 405 according to the invention may further, for example, detect a phase of the two mixer output signals or their phase shift to each other. This may be realized at low cost, as the two mixer output signals are digital anyway. If the first mixer means and/or the second mixer means cause an additional phase shift, then the second phase relation of the output signals of the first and the second mixer means may be set accurately digitally with the help of a further means not indicated in the embodiment illustrated in FIG. 4. This may, for example, be realized digitally by the fact that the two mixer output signals are suitably delayed.

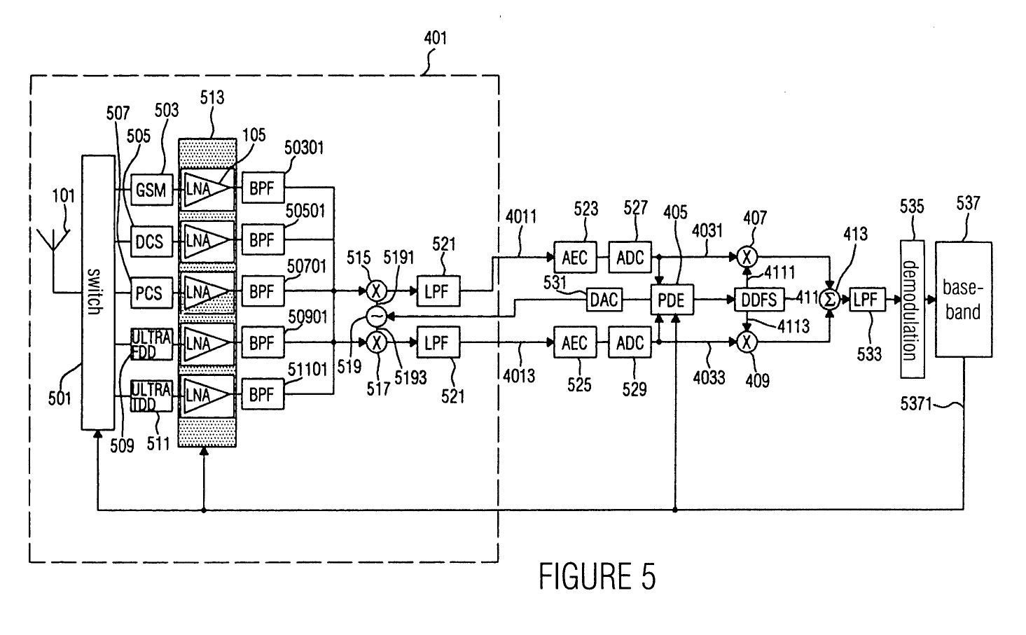

In FIG. 5, a further embodiment of a device for downward mixing according to the present invention is illustrated.

Means 401 for generating the first receive signal 4011 and the second receive signal 4013 on the first intermediate frequency includes the antenna 101 in the embodiment illustrated in FIG. 5, whose output is coupled to a switch 501. The switch 501 comprises a plurality of outputs respectively connected to a band-pass filter. In the embodiment illustrated in FIG. 5, the output signals of the switch 501 are supplied to a GSM band-pass filter 503, a DCS band-pass filter 505, a PCS band-pass filter 507, an ultra FDD band-pass filter 509 and an ultra TDD band-pass filter 511. The output signals of the band-pass filters 503-511 are amplified by an amplification block 513. The amplification block 513 respectively comprises an LNA 105 for amplifying a respective filter output signal. The respective outputs of the LNAs 105 are coupled to band-pass filters. Here, a branch associated with the GSM band-pass filter 503 is coupled to a band-pass filter 50301, a branch associated with the DCS band-pass filter 505 is coupled to a band-pass filter 50501, a branch associated with the PCS band-pass filter 507 is coupled to the band-pass filter 50701, a branch associated with the ultra FDD band-pass filter 509 is coupled to a band-pass filter 50901 and a branch associated with the ultra TDD band-pass filter 511 is coupled to a band-pass filter 51101. The respective outputs of the respective band-pass filters 50301-51101 are connected to each other. A filter output signal is then branched and the branching signals are supplied to a third mixer means 515 and a fourth mixer means 517. The mixer means 515 and the mixer means 517 are implemented as analog mixers in the embodiment illustrated in FIG. 5. For controlling the mixers 515 and 517 a controllable local oscillator 519 is used generating a third control signal 5191 and a fourth control signal 5193. The output signals of the mixers 515 and 517 are low-pass filtered by the low-pass filters 521, so that at a respective filter output the first receive signal 4011 and the second receive signal 4013 are present on the first intermediate frequency. The first receive signal 4011 is supplied to a first amplification controller 523, the second receive signal 4013 is supplied to a second amplification controller 525. An output signal of the first amplification controller 523 (AGC=automatic gain control) is supplied to a first analog/digital converter (ADC) 527. An output signal of the second amplification controller 525 is supplied to a second analog/digital converter 529. The first analog/digital converter 527 provides the digital representation 4031 of the first receive signal 4011, the second analog/digital converter 529 provides the digital representation 4033 of the second receive signal 4013. The digital signal 4031 is supplied to the first mixer means 407, the digital signal 4033 is supplied to the second mixer means 409. Both the first mixer means 407 and also the second mixer means 409 are implemented as digital mixers in the embodiment illustrated in FIG. 5. The digital signals 4031 and 4033 are further supplied to the phase detection means (PDE) 405. An output of the phase detection 405 is coupled to an analog/digital converter 531 whose output signal controls the controllable local oscillator 519. A further output of the phase detection means 405 is connected to the mixer control means 411, which is in this embodiment implemented as a direct digital frequency synthesizer (DDFS). The DDFS 411 provides the first control signal 4111 for controlling the first mixer means 407 and the second control signal 4113 for controlling the second mixer means 409. The digital mixer output signals are supplied to the summation means 413. An output signal of the summation means 413 is low-pass filtered with the help of a low-pass filter 533 (LPF) and supplied to a demodulator 535. The output signals of the demodulator 535 are supplied to a baseband block 537. The baseband block 537 further provides a control signal 5371 received by the phase detection means 405, by the amplification block 513 and by the switch 501.

In the following, the functioning of the embodiment illustrated in FIG. 5 of a device for downward mixing is explained according to the present invention.

According to the embodiment illustrated in FIG. 5, the device for downward mixing indicated there is implemented in order to receive and to process multi-standard receive signals. As the different standards, such as GSM, DCS or PCS are designated by different carrier frequencies, a signal received via the antenna 101 is switched through with the help of the switch 501 to one of the band-pass filters 503-511, when the received signal corresponds to one of the mobile radio standards exemplarily considered in FIG. 5. If, for example, a signal is received which is a GSM signal, then the switch 501 is controlled by the baseband block 537 such that the signal received via the antenna 101 is switched to the GSM band-pass filter 503. The band-pass-filtered signal is then supplied to the amplification block 513 and amplified by the LNA 105. After a subsequent band-pass filtering by the band-pass filter 50301, a thus resulting signal is branched and converted with the help of the mixers 515 and 517 to the first intermediate frequency, wherein the low-pass filters 521 let the signals on the first intermediate frequency pass and reject the higher-frequency signal proportions. For converting the band-pass filter output signals, the mixers 515 and 517 are controlled by the third and the fourth control signals 5191 and 5193. Both control signals are generated by the local oscillator 519 and, apart from a second frequency determined by an oscillation frequency, comprise a second phase difference that may be set with the help of a controllable phase shifter which may be part of the local oscillator 519 and is not illustrated in FIG. 5. The first receive signal 4011 and the second receive signal 4013 which result after the low-pass filtering by the filters 521 are respectively supplied to the first AGC 523 and the second AGC 525. The amplification controllers 523 and 525 have the task to compensate a mismatching of the first receive signal 4011 and the second receive signal 4013 with regard to an amplitude and/or to amplify the two input signals 4011 and 4013 such that both the first analog/digital converter 527 and also the second analog/digital converter 529 are sufficiently controlled so that the converter input signals are adjusted to the converters. After the analog/digital conversion by the converters 527 and 529 the digital signals 4031 and 4033 result on the first intermediate frequency. The phase detection means 405 here detects either the phase of the digital signals 4031 and 4033 or the phase shift between the same in order to control the local oscillator 519 such that the third control signal 5191 and the fourth control signal 5193 comprise the second frequency and a second phase difference, so that the first receive signal 4011 and the second receive signal 4013 comprise the first phase relation to each other which is necessary for an optimum rejection of the image frequency. As the phase detection means 405 is built up in a time-discrete way, the output signal controlling the local oscillator 519 is transferred into a time-continuous range with the help of the analog/digital converter 531.

For adjusting the amplitudes of the first and the second receive signals 4011 and 4013, the phase detection means 405 may further detect the amplitudes of the two digital signals 4031 and 4033 and control the first amplification controller 523 and the second amplification controller 525 on the basis of this amplitude detection such that an amplitude mismatching is eliminated.

The digital signals 4031 and 4033 are converted to the second intermediate frequency by a digital mixing performed with the help of the mixers 407 and 409. The DDFS 411 here digitally synthesizes the first control signal 4111 which controls the mixer 407 and the second control signal 4113 which controls the second mixer 409. Both the first frequency and also the first phase difference of the control signals 4111 and 4113 are set depending on the phase of the digital signals 4031 and 4033 or on their phase difference by controlling the mixer control means 411 by the phase detection means 405, as it was already explained with regard to the embodiment illustrated in FIG. 4. As the mixers 407 and 409 are digital mixers, the digital signals 4031 and 4033 are converted to the second intermediate frequency by a digital multiplication by the control signals 4111 and 4113. By the fact that the phase detection means 405 controls both the local oscillator 519 and also the mixer control means 411, the image frequency proportions may be rejected by a summation of the output signals of the mixers 407 and 409 which is preferably performed digitally. After a low-pass filtering by the filter 533 a thus resulting single sideband signal is demodulated in the demodulator 535 and subjected to a further baseband processing in the baseband block 537. Here, for example, the demodulated signals may be detected and decoded.

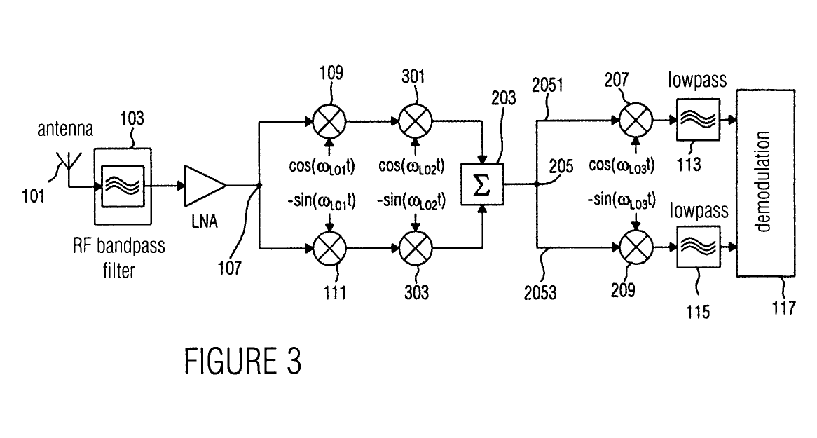

In order to be able to use the advantages of a digital signal processing it would be desirable to obtain an extremely low first intermediate frequency which is, for example, possible with the Weaver structure already discussed in FIG. 3. The effects of the phase and amplitude deviations between the receive signals 4011 and 4013 may, however, only be reduced by analogy with a substantial effort. This problem is solved according to the invention by the fact that parts of the inventive device for downward mixing are implemented digitally. Here, by a skillful analog/digital partitioning a further possibility for a highly precise image frequency rejection is given.

The digitizing of the signals takes place between the mixers 515, 519 and 407 and 409. In order to be able to suitably address the analog/digital converters, the automatic gain controllers are used (AGC). They adjust the input signal to the converters, so that the analog/digital converters are suitably controlled. By this, a reduced input range is achieved. The subsequent digitizing requires a low intermediate frequency, so that the receive signals 4011 and 4013 may be sampled maintaining the sampling theorem. Preferably, the first intermediate frequency comprises some megahertz. Far lower first intermediate frequencies are conceivable, however. In each case, the receive signals 4011 and 4013 are to be oversampled, as on the one hand the receive filters and on the other hand, for example, a 90-degree phase shift between the receive signals 4011 and 4013, which may in this case be interpreted as an I and a Q component, have to be resolvable. The subsequent steps may now be performed digitally. This makes a multiplication possible without errors, which is required for the conversion of the digital signals 4031 and 4033 to the second intermediate frequency. A phase or amplitude deviation is thus not present. Apart from the advantages of an error-free further processing, now with a suitably selected algorithm, for example the already mentioned CORDIC algorithm, a calculation of the amplitude, the phase and the frequency of the digital signals 4031 and 4033 may be performed digitally. This has a decisive advantage that the mentioned errors may be re-calculated and compensated.

If the device for downward mixing illustrated in FIG. 5 is used to receive multi-standard signals, then the frequency range to be processed for example extends from 890 MHz to 2480 MHz. In order to have a possibility to choose between the different receive bands, here, the switch 501 (multiplexer) is arranged preferably behind the antenna output. For this, there are different approaches. The switch 501 may, for example, be selected as a conventional switch. In order to maintain the comfort and switching-time specifications, it is, for example, recommended to use a so-called micromechanical switch, as it is disclosed in the following document: C. Nguyen: Micromechanical components for miniaturized low power communications, IEEE MTT-S 1999. Further, for this task a shuttable filter may be selected. No matter which possibilities of an implementation of the switch 501 are considered, it has to be guaranteed that preferably only one receive path is selected at one time. If two paths would be connected in parallel, the power would be reduced by 3 db. This is not acceptable in mobile radio applications. If several paths are to be connected in parallel, then still further suitable amplifiers would have to be connected in order to compensate for the power loss. The signal amplified by the LNA 105 is again band-pass filtered in order to filter out the harmonic oscillations, for example caused by the non-linearities in the LNA 105. Subsequently, the signal is downward mixed, wherein the mixers 515 and 517 have to be realized in a further spectral range. If this can not be achieved at low cost, then it is possible, for example, to process the GSM frequency range and the remaining bands (over 1800 MHz) separately.

The two digital signals 4031 and 4033 are converted, with the help of the digital mixing by the mixers 407 and 409, to the second intermediate frequency which depends on the first frequency of the control signals 4111 and 4113. If the second intermediate frequency is selected such that the digital signals 4031 and 4033 are not shifted into a baseband, then after the summation by the summation means 413 a single sideband signal results comprising no DC proportions. Alternatively, the digital signals 4031 and 4033 may be converted directly into the baseband with the help of the digital mixers 407 and 409, so that a baseband signal is already made available for the demodulator 535.

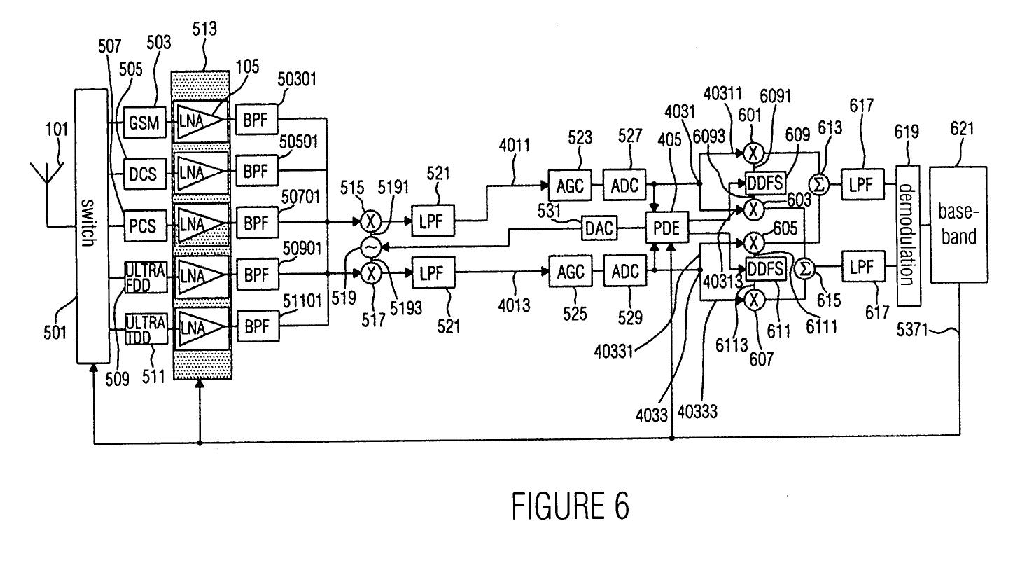

In FIG. 6, a further embodiment of a device for downward mixing according to the present invention is illustrated.

In contrast to the embodiment illustrated in FIG. 5, the digital representation 4031 of the first receive signal 4011 is separated into two paths. A first path 40311 is connected to a fifth mixer 601. A second path 40313 is connected to a sixth mixer 603. The digital representation 4033 of the second receive signal 4013 is also separated into two paths. A third path 40331 is connected to a seventh mixer 605. A fourth path 40333 is connected to an eighth mixer 607. The fifth mixer 601 and the sixth mixer 603 are controlled by a first DDFS 609. In doing so, the DDFS 609 generates a fifth control signal 6091 for controlling the mixer 601 and a sixth control signal 6093 for controlling the sixth mixer 603. The seventh mixer 605 and the eighth mixer 607 are controlled by a second DDFS 611. In doing so, the second DDFS 611 generates a seventh control signal 6111 for controlling the seventh mixer 605 and an eighth control signal 6113 for controlling the eighth mixer 607. The output signals of the fifth mixer 601 and the seventh mixer 605 are summed with the help of a first summation means 613. The output signals of the sixth mixer and the eighth mixer are summed with the help of a second summation means 615. An output signal of the summation means 613 and an output signal of the summation means 615 are filtered with the help of low-pass filters (LPF) 617 preferably comprising an identical characteristic. The respective output signals of the low-pass filters are supplied to a demodulator 619. An output signal of the demodulator 619 is supplied to a baseband block 621.

In the following, the functioning of the embodiment of a device for downward mixing illustrated in FIG. 6 is explained. Here, the functionalities already explained with regard to the embodiment illustrated in FIG. 5 are not explained again.

The digital signals 4031 and 4033 are intermediate frequency signals on the first frequency resulting from the conversion of the receive signal by the mixers 515 and 517. According to the invention, the digital signals are converted on the first intermediate frequency by a digital mixing with the help of the mixers 601, 603, 605 and 607 into a baseband, so that the information-carrying I and Q baseband signals are output directly. After a branching of the digital signal 4031, the first path 40311 is supplied to the digital mixer 601 and the second path 40313 is supplied to the digital mixer 603. The pair of mixers (601, 603) is controlled by the first DDFS 609 controllable by the PDE 405. The DDFS 609 here generates the fifth and the sixth control signals 6091 and 6093, wherein the control signals 6091 and 6093 comprise a certain frequency and a certain phase difference to each other. The frequency of the control signals 6091 and 6093 is selected such that the output signals of the mixers 601 and 603 respectively comprise a signal proportion in the baseband. The mixing by the digital mixers 601 and 603 takes place digitally by a multiplication of the digital signals associated with the paths 40311 and 40313 with the digital control signals 6091 and 6093. The signals associated with the paths 40331 and 40333 are converted by analogy with the help of the seventh mixer and the eighth mixer 605 and 607. The seventh mixer 605 and the eighth mixer 607 are respectively controlled by the seventh control signal 6111 and the eighth control signal 6113, wherein the control signals 6111 and 6113 are generated by the DDFS 611. In doing so, the seventh and the eighth control signal 6111 and 6113 comprise a predetermined frequency and a predetermined phase difference to each other, so that the output signals of the mixers 605 and 607 comprise a signal proportion in the baseband. If the third control signal 5191 is a cosine signal and if the fourth control signal 5193 is a sine signal, then the digital representation 4031 of the receive signal 4011 comprises a cosine proportion on the first intermediate frequency and the digital representation 4033 of the second receive signal 4013 comprises a sine proportion on the first intermediate frequency. If the digital signals 4031 and 4033 have a 90-degree phase shift to each other, then the mixers 601 and 603 and 605 and 607 are respectively controlled with control signals which are also 90 degrees phase-shifted. Here, for example, the mixer 601 is controlled with a cosine signal and the mixer 603 is controlled with a sine signal, while the mixer 605 is controlled with a sine signal and the mixer 607 is controlled with a cosine signal. Employing trigonometric laws, after an addition performed by the summation means 613 and 615 baseband quadrature signals are generated, wherein the image frequencies are rejected. After the low-pass filtering by the filters 617, the signal may be demodulated by the demodulator 619, so that in the baseband block 621 for example a subsequent decoding and detection may be performed. As both the DDFS 609 and also the second DDFS 611 are controlled by the PDE 405, the phases of the control signals 6091, 6093 and 6111 and 6113 may be set such that the output signals of the summation means 613 and 615 are image frequency proportion-free quadrature signals. Similarly, the frequency of the control signals 6091, 6093 and 6111 and 6113 may then be set such that an accurate baseband mixing may be performed. It is an advantage of the inventive device for downward mixing illustrated in FIG. 6 that a demodulation effort is reduced by the fact that the signal is present as a baseband signal at the output of the structure. A further advantage of this receiver is an I/O mismatching that may be calibrated. In addition to this, by a differential measurement of the orthogonal baseband signals and for the image frequency rejection, further a locked loop may be set up, so that errors in the subsequent demodulation are reduced. In particular, the structure illustrated in FIG. 6 is suitable for a broad-band reception, as the frequency of the control signals 6091, 6093, 6111 and 6113 may be set digitally and thus accurately, so that a demand on the local oscillator 519 regarding its broad-band characteristic may be eased.

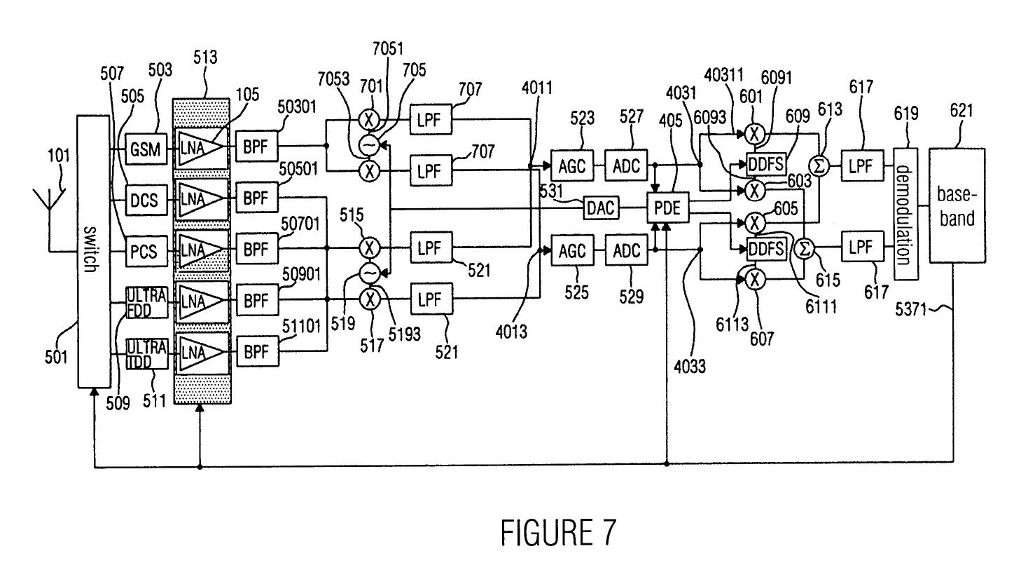

In FIG. 7, a further embodiment of a device for downward mixing according to the present invention is illustrated. In contrast to the embodiment illustrated in FIG. 6, a GSM receive signal is processed separately. After the band-pass filtering by the filter 50301, the high-frequency GSM signal is branched and the branching signals are respectively supplied to a ninth mixer 701 and a tenth mixer 703. The mixers 701 and 703 are controlled by a local oscillator 705 providing a ninth control signal 7051 and a tenth control signal 7053. The output signals of the mixers 701 and 703 are respectively supplied to a low-pass filter 707.

The receive signals associated with other standards, for example DCS, PCS, ultra FDD and ultra TDD are converted with the help of the mixer arrangement of FIG. 7 to the first intermediate frequency. Here, both the local oscillator 519 and also the local oscillator 705 are controlled by the PDE.

In the following, the functioning of the device for downward mixing of the embodiment illustrated in FIG. 7 according to the present invention is explained.

If it is not possible to realize the mixers 515 and 517 illustrated in FIG. 6 in a broad frequency range in MOS technology, then preferably the frequency range is, for example, separately implemented and downward mixed for GSM. In this embodiment, GSM signals are processed separately, as GSM is located in a frequency range between 935-960 MHz and, for example, the DCS standard is located in a frequency range between 1805-8880 MHz. If the GSM path is processed separately, then the mixers 701 and 703 may be controlled by control signals 7051 and 7053 generated by the local oscillator 705. Here, the local oscillator 704 comprises an oscillator frequency deviating from an oscillator frequency of the local oscillator 519, so that the local oscillators 705 and 519 do not have to be implemented in a highly broad-banded way, which would be necessary for a conversion of all multi-standard signals. With the help of the receive structure illustrated in FIG. 7, now the local oscillators 705 and 519 may be cheaper and more stable.

If now a GSM signal is to be received, then the baseband block 621 provides the signal 5371 controlling the switch 501 such that a signal received via the antenna 101 is switched through to the GSM filter 503 while the remaining filters 505, 507, 509 and 511 receive no signal. The GSM receive signal is supplied after the amplification by the LNA 105 and after the band-pass filtering by the band-pass filter 50301 to the mixer pair 701 and 703. After the mixing to the first intermediate frequency, at the inputs of the amplification controllers 523 and 525 the digital signals 4011 and 4013 are applied resulting from a downward mixing of the GSM receive signal. The PDE 405 here controls both the phase and also the frequency of the control signals 7051 and 7053 in an analog way, like the phase and the frequency of the control signals 5191 and 5193 are controlled, as it was already explained in connection with the embodiment illustrated in FIG. 5 or in FIG. 6.

If no GSM signal is to be received but, for example, a DCS signal, then the switch 501 is controlled by the signal 5371 such that a signal received via the antenna 101 is supplied to the DCS band-pass filter 505, while the other filters 503, 507, 509 and 511 receive no signal. As the GSM path is separated, only the DCS signal is converted to the first intermediate frequency, so that at the inputs of the amplification controllers 523 and 525 the digital signals 4011 and 4013 are applied which are respective digital representations of the DCS receive signal.

For downward mixing the different multi-standard signals, for a conversion of those signals to the first intermediate frequency, for example the oscillator frequency of the oscillator 519 may be varied so that the receive signals may be converted to the first intermediate frequency which may, for example, be fixed. For this, the oscillator frequency should be calibrated suitably before a desired multi-standard signal, for example an ultra TDD signal, is received. In order to make a frequency selection, i.e. to set a suitable oscillation frequency, for example by the local oscillator 519, as it is illustrated in FIG. 7, the receive structure illustrated in FIG. 7 may be calibrated before receiving a signal. This calibration may, however, also be performed during the empty time-slots, always resulting in connection with a TDMA operation (TDMA=time division multiple access).

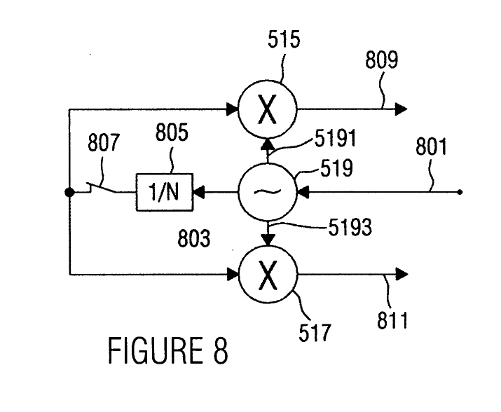

In FIG. 8, a further embodiment of a frequency selection means according to the present invention is illustrated. The frequency selection means in this embodiment includes the third mixer 515 and the fourth mixer 517, as it was discussed in connection with the embodiment illustrated in FIG. 7, which are controlled by the third control signal 5191 and by the fourth control signal 5193. The local oscillator 519 is controlled by a signal 801. In addition to this, the local oscillator 519 provides a frequency signal 803 which is supplied to a frequency divider 805. In addition to this, the frequency selection means illustrated in FIG. 8 comprises a switch 807 switching an output signal of the frequency divider 805 through to the mixers 515 and 517 or not.

In the following, the functioning of the embodiment of the frequency selection means illustrated in FIG. 8 is explained.

If the controllable local oscillator 519 is controlled using the control signal 801, then the local oscillator 519 provides the frequency signal 803 whose frequency depends on an oscillation frequency of the oscillator 519 that may be set by the control signal 801. The frequency signal 803 is then supplied to the frequency divider 805. According to the embodiment illustrated in FIG. 8, the frequency divider 805 provides the output signal, whose frequency is lower by a factor N than the frequency of the frequency signal 803. If the switch 807 is now closed, then the output signal of the frequency divider 805 is supplied to the mixers 515 and 517. As the mixers 515 and 517 are controlled by the control signals 5191 and 5193, now a mixing of the output signal of the frequency divider 805 with the third control signal 5191 and with the fourth control signal 5193 takes place. The mixers 515 and 517 here provide the output signals 809 and 811 which are a result of this mixing. By the fact that the frequency of the output signal of the frequency divider 805 is lower than the frequency of the control signals 5191 and 5193 by a factor of N, now by a control of the local oscillator 519 and by a selection of a divider ratio N the oscillation frequency of the local oscillator 519 may be set such that the receive signal is converted to the first intermediate frequency.

The structure illustrated in FIG. 8 is in particular advantageous when the receive signals are encoded with the help of a frequency-hopping scheme. In a frequency-hopping scheme, a carrier frequency of the transmitted signal is changed in consecutive time-slots, so that a band-spread effect results, contributing to an improvement of the signal to noise ratio in a receiver. As a frequency plan is known after the carrier frequency of the transmission signal is changed, preferably on the receive side this frequency plan may be followed so that the receive signal is converted independent of a current carrier frequency for example to the fixed first intermediate frequency. The calibration of the inventive frequency selection means may here be performed during the empty time-slots, as during the empty time-slots no information transmission takes place. With the help of means not indicated in FIG. 8, which may, for example, be the phase detection means 405 of FIG. 7, the oscillation frequency of the oscillator 519 may be tracked when, for example, a frequency or a phase of the output signals 809 and 811 is detected and the oscillation frequency of the oscillator 519 is tracked on the basis of this detection, so that at the end of the empty time-slot the oscillation frequency of the local oscillator 519 required for a conversion of the receive signal to the first intermediate frequency is set.

A further advantage of the inventive receiver structure is the digital frequency synthesizing. By a digital frequency measurement that may, for example, be realized with the already mentioned CORDIC algorithm, it is possible to regulate the frequency digitally or also by analogy. For a multi-standard structure a frequency generation is a problem, because, as it was already mentioned, based on the required broadbandedness, for example, of used local oscillators an accurate setting of an oscillation frequency is problematic. This difficulty may be substantially eliminated with the inventive semi-digital structure. If the frequency should be regulated digitally, then only a small range is settable. For example for a 200 kHz GSM channel this may possibly be realized and represents a good alternative.

According to the invention, further a feedback to the analog part is provided. The feedback analog signal may, for example, address a voltage controlled oscillator (VCO). This VCO may only be realized with a greater part tolerance in MOS technology. From this, a frequency inaccuracy of about 20% results. In order to now be able to set a highly accurate frequency, the overall system has to be calibrated once before putting it into operation, which may be performed with the help of the frequency selection means illustrated in FIG. 8. The measured values are subsequently stored in a memory and are available then. After this first calibration further calibration measures may be necessary in order to adjust the receiver, for example, to changing conditions (temperature drift, aging, etc.). This is possible with a measurement of the frequency in test signals applied as defined, which are generated by the circuit itself, as it is illustrated in FIG. 8 (e.g. control signal 801). A sampling of the high-frequency signal is possible with the analog/digital converters 527 and 529, as they are illustrated in FIG. 7, because a high undersampling may be realized. The resulting test signal, for example the output signal 809 of the mixer 515, is freely settable in an amplitude and may be adjusted to an aliasing noise depending on the selected undersampling rate.

The empty time-slots resulting in a TDMA operation (TDMA=time division multiple access) are used according to the invention in order to mix the signal generated by the oscillator 519 with a defined fractional or non-fractional signal divided by the factor N. The frequency to be measured may now be set by the divider ratio N such that the calibration takes place in an operating range of the receiver. The statistical DC voltage proportions resulting by cross-talk may be measured and be subtracted from the receive signal, for example in a burst reception. This arrangement requires no separate crystal oscillator and no separate temperature compensation. The calibration frequency, i.e. the frequency of such a measurement, allows a setting of the energy required for the calibration. Quickly changing boundary conditions may be compensated in the burst clock.

The UMTS system (UMTS=universal mobile telecommunications system), for example, uses CDMA (CDMA=code division multiple access) as a multiple access method. In this method, no empty time-slots are available. So that a multi-standard operation may be guaranteed, a continuous adjustment, for example a frequency correction, is necessary. If, for example, for UMTS a separate temperature-compensated crystal oscillator (TCXO) is provided, then it is possible by the freely settable divider for the test signal to perform, during the reception of data, a frequency calibration on a separate frequency which is different from the carrier frequency. This definedly selected signal may be strongly attenuated in the amplitude so that no interferences occur. Depending on how far the receive and the rest frequency are apart, interferences occur. Further, the amplification controllers 523 and 525, as they are illustrated in FIG. 7, would block the receive signal. The two last-mentioned disadvantages may, for example, be prevented by an amplitude attenuation.

The inventive device for downward mixing is distinguished by the fact that it enables a more accurate image frequency rejection than it is the case in a use of the receiver structure known from the prior art, for example having the form illustrated in FIG. 3. In order to obtain an impression of the error quantities, the quantity IRR (image reject ratio) is to be used. This quantity is a measure for the image frequency rejection in db. This ratio of the image frequency rejection is obtained by adding an erroneous amplitude and an error phase to the Q path and, for example, analytically calculating the Weaver structure illustrated in FIG. 3. In the following document: J. Rodell: A 1.9 GHz wide band IF double conversion CMOS receiver for cordless telephone applications, this was calculated for the conventional Weaver structure. For the structure modified here, new calculations are necessary. The resulting form of the IRR is:

$$IRR ( db ) 10 \cdot log [ \frac{1 + {( 1 + Δ G )}^{2} + 2 \cdot ( 1 + Δ G ) \cdot cos ( Δ ϕ )}{1 + {( 1 + Δ G )}^{2} - 2 \cdot ( 1 + Δ G ) \cdot cos ( Δ ϕ )} ]$$

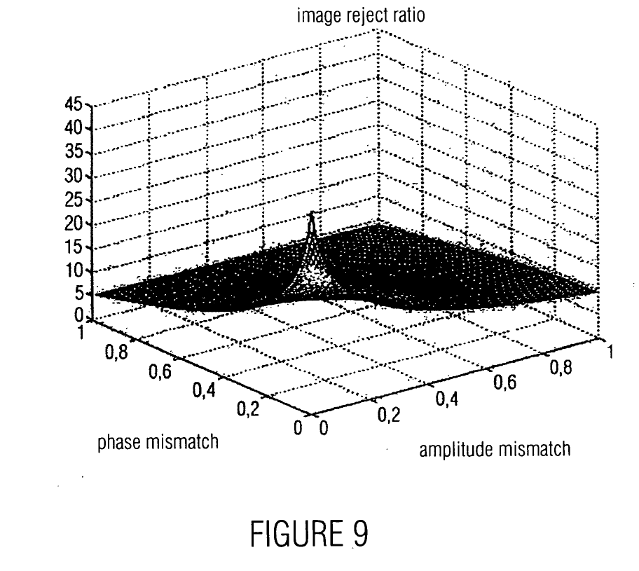

Here, ΔG represents an amplitude deviation and Δφ indicates a phase deviation in degrees. In FIG. 9 a simulation result of an image rejection ratio is illustrated in a use of analog receive stages. This graph clearly illustrates that a slight phase deviation, for example of 0.1 degrees, reduces the image frequency rejection to about 37 dB. This is a value conventional in analog circuits. If this phase insecurity is now to be compensated digitally, then a resolution of, for example, 3600 sample points per period is required. As there is further the possibility to shift an I path and also a Q path with regard to each other, also half of the sampling points would be sufficient. Such an oversampling would possibly exceed the requirements for analog/digital converters. According to the invention it is not possible, however, to detect and correct absolute errors but only differential errors, whereby an algorithmic calculation may also be performed at a low rate. The formulation of the geometric Pythagoras is a first approach.

$${\int }_{- \frac{T}{2}}^{+ \frac{T}{2}} {cos}^{2} ( ω \cdot t ) + {cos}^{2} ( ω \cdot t ) ⅆ t = 0$$

The integration by a sum has to be replaced digitally. If this formulation is calculated, i.e. squaring the digital value pairs, subsequently adding and summing, then the integral value is only equal to 0 in a perfect adjustment. Each positive or negative deviation is a measure for a quantity of this deviation. This digital measure could now also be converted by analogy and as a differential voltage signal, for example, control a varactor (voltage-dependent capacitor). This varactor should be a component of the phase shifter between the I and the Q component. A precondition for such a calculation is, however, a 100% amplitude adjustment. As the amplitude calculation is easy to implement digitally, this adjustment operates convergently.

The inventive structure allows to basically eliminate the known disadvantages from a heterodyne receiver, like, for example, frequency planning problems. The inventive device further allows designing the expensive heterodyne receivers in a flexible enough way for a multi-standard operation. By an analog/digital partitioning, further substantial receiver elements may now be implemented digitally, like, for example, the channel selection filters, mixers, etc. This has the decisive advantage of a parameter-controlled reconfiguration of the elements. The inventive correction of the imperfect analog characteristics of each receiver offers a high degree of accuracy, and thus there is, in particular in the field of image frequency rejection, a higher attenuation than is the case with structures according to the prior art. Apart from an image frequency rejection, also amplitudes and phase differences may be eliminated using the inventive structure, like an I/Q mismatch, which makes the demodulation more difficult or deteriorates the same.

Depending on the conditions, the inventive method for downward mixing an input signal into an output signal may be implemented in hardware or in software. The implementation may take place on a digital storage medium, in particular a floppy disc or a CD with electronically readable control signals which may cooperate with a programmable computer system so that the corresponding method is performed. In general, the invention also consists in a computer program product having a program code stored on a machine-readable carrier for performing the inventive method when the computer program product runs on a computer. In other words, the invention may also be realized as a computer program having a program code for performing the method when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A device for downward mixing an input signal into an output signal, comprising:
a generator for generating a first receive signal and a second receive signal on a first intermediate frequency, wherein the generator for generating is implemented in order to generate the first receive signal and the second receive signal with a predetermined first phase relation to each other;
a converter for analog/digital converting the first receive signal on the first intermediate frequency in order to obtain a digital representation of the first receive signal and for analog/digital converting the second receive signal in order to obtain a digital representation of the second receive signal;
a phase detector for detecting a phase difference between the digital representation of the first receive signal and the digital representation of the second receive signal;
a first mixer for converting the digital representation of the first receive signal onto a second intermediate frequency;
a second mixer for converting the digital representation of the second receive signal onto the second intermediate frequency;
a mixer controller for controlling the first mixer with a first control signal comprising a first frequency and for controlling the second mixer with a second control signal comprising the first frequency, wherein the first and the second control signal comprise a predetermined first phase difference;
a summator for summing the output signals of the first mixer and the second mixer;
wherein the phase detector is implemented in order to control the generator for generating in order to reduce a mismatch between the digital representation of the first receive signal and the digital representation of the second receive signal and to control the mixer controller in order to digitally compensate a remaining mismatch between the digital representation of the first receive signal and the digital representation of the second receive signal so that the output signals of the first mixer and the second mixer are in a predetermined phase relation to each other, so that an image frequency rejection occurs.

2. The device according to claim 1, wherein the phase detector is further implemented in order to respectively detect an amplitude and a frequency of the digital representation of the first receive signal and/or the second receive signal.

3. The device according to claim 2, wherein the phase detector comprises a digital/analog converter for generating an analog control signal from the quantities respectively detected by the phase detector for controlling the generator for generating.

4. The device according to claim 1, wherein the generator for generating the first receive signal and the second receive signal further comprises:
a brancher for dividing the receive signal into a first and a second partial receive signal;
a third mixer for providing the first receive signal by converting the first partial receive signal onto the first intermediate frequency;
a fourth mixer for providing the second receive signal by converting the second partial receive signal onto the first intermediate frequency;
a further mixer controller for controlling the third mixer using a third control signal comprising a second frequency, and for controlling the fourth mixer with a fourth control signal comprising the second frequency, wherein the third and the fourth control signals comprise a predetermined second phase difference.

5. The device according to claim 4, wherein the further mixer controller comprises a local oscillator for generating the third control signal and the fourth control signal and a controllable phase shifter for setting the second phase difference between the third and the fourth control signal;
wherein the phase shifter is controlled by the phase detector.

6. The device according to claim 5, wherein the local oscillator is controllable by the phase detector in order to generate the third control signal and the fourth control signal using the second frequency.

7. The device according to claim 6, wherein the generator for generating further comprises a frequency selector in order to set the second frequency depending on a carrier frequency associated with the receive signal.

8. The device according to claim 1, wherein the converter comprises a first analog/digital converter for obtaining the digital representation of the first receive signal and a second analog/digital converter for obtaining the digital representation of the second receive signal.

9. The device according to claim 1, wherein the converter further comprises a first controllable amplification controller for setting an amplitude of the first receive signal, and a second controllable amplification controller for setting an amplitude of the second receive signal in order to control the first and the second analog/digital converter;
wherein the first and the second controllable amplification controllers are controlled by the phase detector on the basis of the detected respective amplitude of the digital representation of the first receive signal and/or the second receive signal.

10. The device according to claim 1, wherein the first control signal and/or the second control signal provided by the mixer controller are respectively digital.

11. The device according to claim 10, wherein the first phase difference between the first and the second control signal is digitally settable.

12. The device according to claim 10, wherein the first mixer and the second mixer respectively comprise a digital multiplier for digitally converting the digital representation of the first receive signal and the digital representation of the second receive signal onto the second intermediate frequency.

13. The device according to claim 10, wherein the mixer controller is controllable for setting the first phase difference between the first control signal and the second control signal.

14. The device according to claim 10, wherein the mixer controller is further implemented in order to control a frequency of the first and the second control signal, wherein the frequency of the first and the second control signal is digitally settable.

15. The device according to claim 1, wherein the summator is digital.

16. A method for downward mixing an input signal into an output signal, comprising:
generating a first receive signal and a second receive signal on a first intermediate frequency;
generating a predetermined first phase relation between the first receive signal and the second receive signal;
analog/digital converting the first receive signal on the first intermediate frequency in order to obtain a digital representation of the first receive signal, and analog/digital converting the second receive signal on the first intermediate frequency in order to obtain a digital representation of the second receive signal;
detecting a phase difference between the digital representation of the first receive signal and the digital representation of the second receive signal;
changing a phase relation between the first receive signal and the second receive signal in order to reduce a mismatch between the digital representation of the first receive signal and the digital representation of the second receive signal;
generating a first control signal and a second control signal for converting the digital representation of the first receive signal and the digital representation of the second receive signal to a second intermediate frequency;
generating a predetermined phase difference between the first and the second control signal in order to digitally compensate for a remaining mismatch between the digital representation of the first receive signal and the digital representation of the second receive signal in the conversion to the second intermediate frequency;
converting the digital representation of the first receive signal and the digital representation of the second receive signal to the second intermediate frequency, so that the converted digital representation of the first receive signal and the converted digital representation of the second receive signal are in a predetermined phase relation to each other;
summing the converted digital representation of the first and the second receive signal so that an image frequency rejection occurs based on the predetermined phase relation.

17. A computer program having a program code for performing the method for downward mixing an input signal into an output signal, comprising:
generating a first receive signal and a second receive signal on a first intermediate frequency;
generating a predetermined first phase relation between the first receive signal and the second receive signal;
analog/digital converting the first receive signal on the first intermediate frequency in order to obtain a digital representation of the first receive signal, and analog/digital converting the second receive signal on the first intermediate frequency in order to obtain a digital representation of the second receive signal;
detecting a phase difference between the digital representation of the first receive signal and the digital representation of the second receive signal;
changing a phase relation between the first receive signal and the second receive signal in order to reduce a mismatch between the digital representation of the first receive signal and the digital representation of the second receive signal;
generating a first control signal and a second control signal for converting the digital representation of the first receive signal and the digital representation of the second receive signal to a second intermediate frequency;
generating a predetermined phase difference between the first and the second control signal in order to digitally compensate for a remaining mismatch between the digital representation of the first receive signal and the digital representation of the second receive signal in the conversion to the second intermediate frequency;
converting the digital representation of the first receive signal and the digital representation of the second receive signal to the second intermediate frequency, so that the converted digital representation of the first receive signal and the converted digital representation of the second receive signal are in a predetermined phase relation to each other;
summing the converted digital representation of the first and the second receive signal so that an image frequency rejection occurs based on the predetermined phase relation;
when the computer program runs on a computer.
